(19) United States
(12) Patent Application Publication
(10) Pub. No.: US 2025/0200739 A1
(43) Pub. Date: Jun. 19, 2025

(54) INFORMATION PROCESSING APPARATUS, INFORMATION PROCESSING METHOD, AND NON-TRANSITORY COMPUTER-READABLE MEDIUM

(71) Applicant: CANON KABUSHIKI KAISHA, Tokyo (JP)

(72) Inventor: SHU KATO, Kanagawa (JP)

(21) Appl. No.: 18/977,525

(22) Filed: Dec. 11, 2024

(30) Foreign Application Priority Data
Dec. 15, 2023 (JP) 2023-212324

(51) Int. Cl. G06T 7/00; G06V 10/25

(52) U.S. Cl. CPC G06T 7/0004; G06V 10/25

(57) ABSTRACT

An information processing apparatus is provided. The apparatus obtains information of defect areas in an image of a structure. The defect areas correspond to planar defects in the structure. The apparatus determines whether to combine one defect area with another defect area based on a positional relationship between the one defect area and the other defect area. The apparatus combines the one defect area with the other defect area based on a result of the determination.

### BACKGROUND

### Field

The present disclosure relates to an information processing apparatus, an information processing method, and a non-transitory computer-readable medium, and especially to a technique to detect a defect in a structure.

### Description of the Related Art

In recent years, defects (e.g., cracks) in a structure are detected using image processing. For example, Japanese Patent Laid-Open No. 2019-200213 discloses vectorization of damage information related to damage in a structure, and generation of a plurality of defect vectors having an initial point and a terminal point. Also, Japanese Patent Laid-Open No. 2019-200213 discloses generation of a new damage vector by connecting initial points or terminal points of two damage vectors. This method allows a user to grasp a connection relationship between damage vectors.

### SUMMARY

According to an embodiment, an information processing apparatus comprises one or more memories storing instructions and one or more processors that execute the instructions to obtain information of defect areas in an image of a structure, the defect areas corresponding to planar defects in the structure; determine whether to combine one defect area with another defect area based on a positional relationship between the one defect area and the other defect area; and combine the one defect area with the other defect area based on a result of the determination.

According to another embodiment, an information processing method comprises obtaining information of defect areas in an image of a structure, the defect areas corresponding to planar defects in the structure; determining whether to combine one defect area with another defect area based on a positional relationship between the one defect area and the other defect area; and combining the one defect area with the other defect area based on a result of the determination.

According to still another embodiment, a non-transitory computer-readable medium stores instructions executable by a computer to perform a method comprising: obtaining information of defect areas in an image of a structure, the defect areas corresponding to planar defects in the structure; determining whether to combine one defect area with another defect area based on a positional relationship between the one defect area and the other defect area; and combining the one defect area with the other defect area based on a result of the determination.

Further features of various embodiments will become apparent from the following description of exemplary embodiments (with reference to the attached drawings).

### BRIEF DESCRIPTION OF THE DRAWINGS

FIG. 1 is a block diagram showing an exemplary hardware configuration of an information processing apparatus according to one embodiment.

FIG. 2 is a block diagram showing an exemplary functional configuration of the information processing apparatus according to one embodiment.

FIG. 3 is a diagram showing an example of a browsing screen of image analysis results.

FIG. 4 is a diagram showing an example of an edit screen of image analysis results.

FIG. 5 is a flowchart showing an example of an information processing method performed by the information processing apparatus.

FIGS. 6A and 6B are diagrams illustrating an example of a method of combining defect areas.

FIGS. 7A and 7B are diagrams illustrating an example of a method of combining defect areas.

FIGS. 8A and 8B are diagrams illustrating an example of a method of combining defect areas.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

Planar defects, such as water leakage, exfoliation, efflorescence, an exposed steel bar, and a rusty fluid, are also known as defects in a structure. When a group of defects has been detected as two or more separate defects, the defects become difficult to search for, examine, and evaluate. Meanwhile, a large burden is imposed on a task of a user to designate a correct defect region for the purpose of correcting the result of detection of defects. Also, with the method of Japanese Patent Laid-Open No. 2019-200213, a connection relationship between planar defects cannot be grasped.

An embodiment of the present disclosure enables easy correction of the result of detection of a planar defect.

An information processing apparatus according to one embodiment can combine defect areas with each other. In the present specification, a defect area is a specific region in an image of a structure. No particular limitation is placed on the structure. The structure can be, for example, an expressway, a bridge, a tunnel, a dam, or the like. Images of structures may be the surfaces (e.g., side surfaces, wall surfaces, or ceiling surfaces) of these structures.

A defect area corresponds to a planar defect in a structure. A defect corresponding to a defect area is, for example, damage that extends on the same plane, such as water leakage, exfoliation, efflorescence, an exposed steel bar, and a rusty fluid. Such a defect may occur on a concrete surface due to a crack in a structure and other factors. Such a defect area is indicated by a set of points that define the contour of the area, or a set of vertices of a polyline that defines the contour of the area. In one embodiment, a defect area corresponds to an area where at least one of water leakage, exfoliation, efflorescence, an exposed steel bar, and a rusty fluid has occurred in a structure.

Also, an information processing apparatus according to one embodiment can combine defect areas with each other based on a defect line. A defect line corresponds to a line defect in a structure. In the present specification, a defect line is one line segment or polyline in an image of a structure. Such a defect line is indicated by a set of coordinates of end points or vertices of one line segment or polyline. Information indicating a width may be further appended to a defect line. A defect corresponding to defect line is, for example, a crack in a structure. A defect may be a crack that occurs on a concrete surface due to damage or deterioration in a structure or other factors. A crack is a line damage which occurs on, for example, a wall surface of a structure due to deterioration caused by aging, the impact of an earthquake, and the like, and which has an initial point, a terminal point, a length, and a width. Also, a defect line may correspond to a line mark on a structure. The line mark may be a trace of a chalk drawn along a crack in a structure.

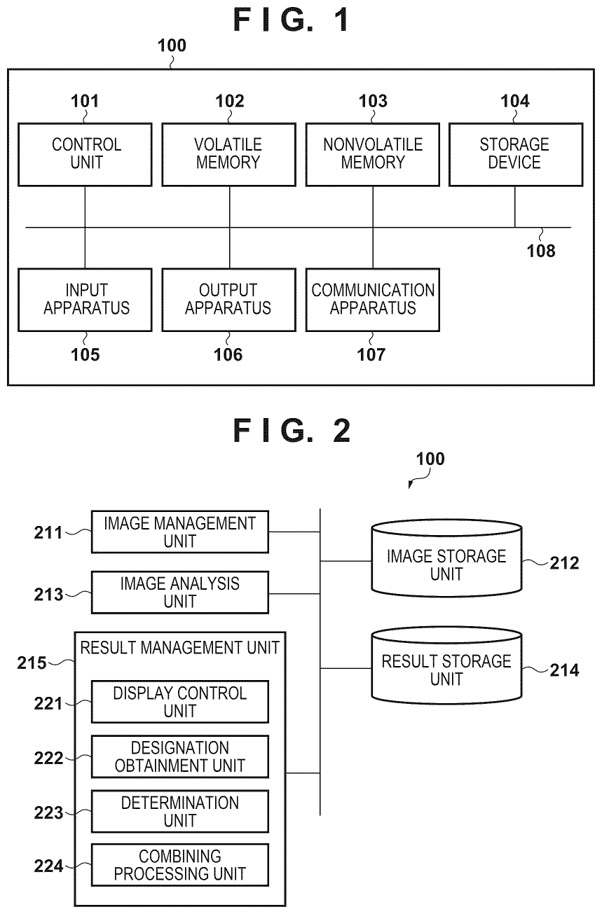

FIG. 1 is a block diagram showing an example of a hardware configuration of an information processing apparatus according to one embodiment. In the embodiment described below, a computer operates as an information processing apparatus 100. Note that processing of the information processing apparatus according to the present embodiment may be realized by a single computer. Also, the information processing apparatus according to the present embodiment may be composed of a plurality of computers. That is to say, the functions of the information processing apparatus according to the present embodiment may be dispersed to a plurality of computers as necessary. These plurality of computers are connected to one another in a communication-enabled manner, and are capable of executing processing of the information processing apparatus in coordination with one another.

The information processing apparatus 100 includes a control unit 101, a volatile memory 102, a nonvolatile memory 103, a storage device 104, an input apparatus 105, an output apparatus 106, a communication apparatus 107, and a system bus 108.

The control unit 101 performs integrated control on the entirety of the information processing apparatus 100. The control unit 101 can include a processor. The processor can be a computation processor, such as a central processing unit (CPU) and a microprocessor unit (MPU).

The volatile memory 102 temporarily stores a program or data supplied from an external apparatus or the like. The volatile memory 102 can be, for example, a random-access memory (RAM).

The nonvolatile memory 103 stores a program executed by the processor of the control unit 101, and parameters. The nonvolatile memory 103 can be, for example, a read-only memory (ROM).

The storage device 104 can store a program or data. The storage device 104 may be a semiconductor memory or a magnetic disk. The storage device 104 can be an internal device built in the information processing apparatus 100, such as a hard disk and a memory card. Also, the storage device 104 may be an external device that is attachably and removably connected to the information processing apparatus 100, such as a hard disk and a memory card. Furthermore, the storage device 104 may include a disc drive that reads out/writes data from/to an optical disc, such as a DVD and a Blu-ray Disc.

The input apparatus 105 accepts a user operation. The input apparatus 105 is, for example, a mouse, a keyboard, a touch panel, or the like. The input apparatus 105 can output an instruction related to the accepted user operation to the control unit 101.

The output apparatus 106 outputs information to a user. The output apparatus 106 can be a display apparatus, such as a liquid crystal display (LCD) and an organic EL display. Such an output apparatus 106 can display data held by the information processing apparatus 100, or data supplied from an external device.

The communication apparatus 107 is an apparatus that connects the information processing apparatus 100 to a network, such as the Internet and a local area network (LAN), in a communication-enabled manner.

The system bus 108 is a data transmission path between the discrete components that compose the information processing apparatus 100. The system bus 108 can include an address bus, a data bus, and a control bus that enable exchange of data.

The nonvolatile memory 103 can store an operating system (OS), which is basic software executed by the control unit 101, and applications that realize applicative functions in coordination with the OS. Furthermore, the nonvolatile memory 103 may store an application for executing later-described image analysis processing in which the information processing apparatus 100 detects a defect from a shot image of a structure that is an inspection target.

Processing of the information processing apparatus 100 according to the present embodiment is realized by the control unit 101 reading in and executing software provided by an application. That is to say, the functions of each unit shown in later-described FIG. 2 and the like can be realized by the processor included in the control unit 101 executing a program stored in a memory like the volatile memory 102, nonvolatile memory 103, or storage device 104. Note that an application includes software for using the basic functions of the OS installed in the information processing apparatus 100. Meanwhile, the OS of the information processing apparatus 100 may include software for realizing processing in the present embodiment.

FIG. 2 is a block diagram showing an example of a functional configuration of the information processing apparatus 100. The information processing apparatus 100 includes an image management unit 211, an image storage unit 212, an image analysis unit 213, a result storage unit 214, and a result management unit 215. Each function of the information processing apparatus 100 can be configured using hardware and software. As stated earlier, while the functions of the information processing apparatus 100 shown in FIG. 2 can be realized by a computer, a part or all of the functions of the information processing apparatus 100 may be realized by dedicated hardware. Note that the information processing apparatus 100 may be realized by a system in which one or more computers and servers are connected via a network.

The image management unit 211 has a function of storing, deleting, and browsing images, displaying a list of images, and the like. For example, the image management unit 211 can store an inspection target image into the image storage unit 212. In the present embodiment, a user inputs the inspection target image to the information processing apparatus 100. The image storage unit 212 stores data of the image.

The image analysis unit 213 detects a defect from the inspection target image. A method of detecting a defect is not limited in particular. The image analysis unit 213 can detect a defect using artificial intelligence (AI) with the aid of, for example, a machine learning technique. Specifically, the image analysis unit 213 can detect a defect from the inspection target image by performing image analysis with respect to the inspection target image using a trained model that has been generated through deep learning. Then, the image analysis unit 213 can store information indicating the result of detection of the defect into the result storage unit 214. The result storage unit 214 stores the result of image analysis.

In the present embodiment, a defect in an inspection target (e.g., a wall surface of a concrete building) is detected by performing image analysis that uses the trained model with respect to an image obtained by shooting the inspection target with a camera. In a case where the defect is a crack, a defect line corresponding to the defect is generated through the image analysis. Such a defect line indicates the result of vectorization of the defect. Information indicating the length and the width of the crack can be appended to the defect line. In a case where the defect is water leakage, exfoliation, efflorescence, an exposed steel bar, a rusty fluid, or the like, a defect area corresponding to the defect is generated through the image analysis. Such a defect area indicates the result of transforming the defect into an area using a shape that encloses the defect (a specific example is a circle, a rectangle, or the like).

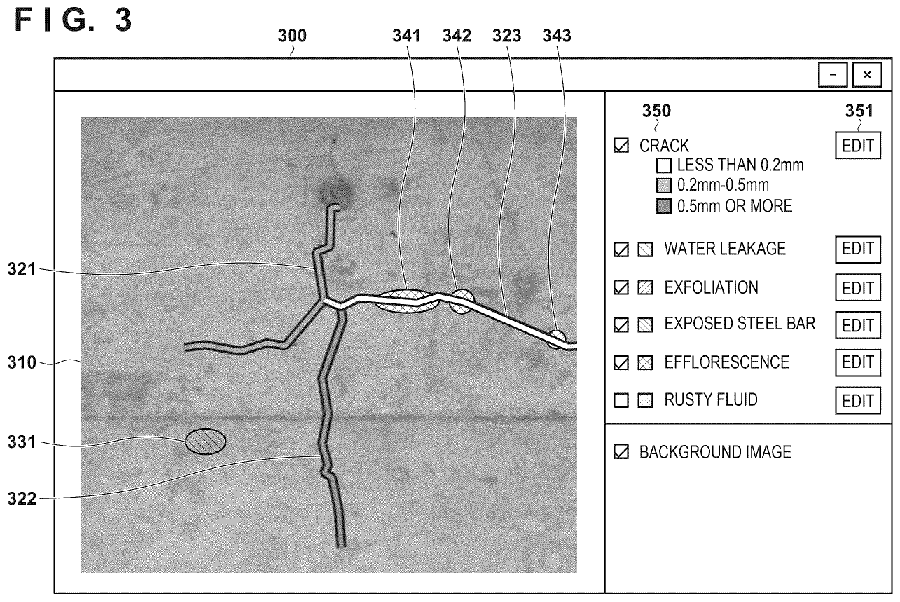

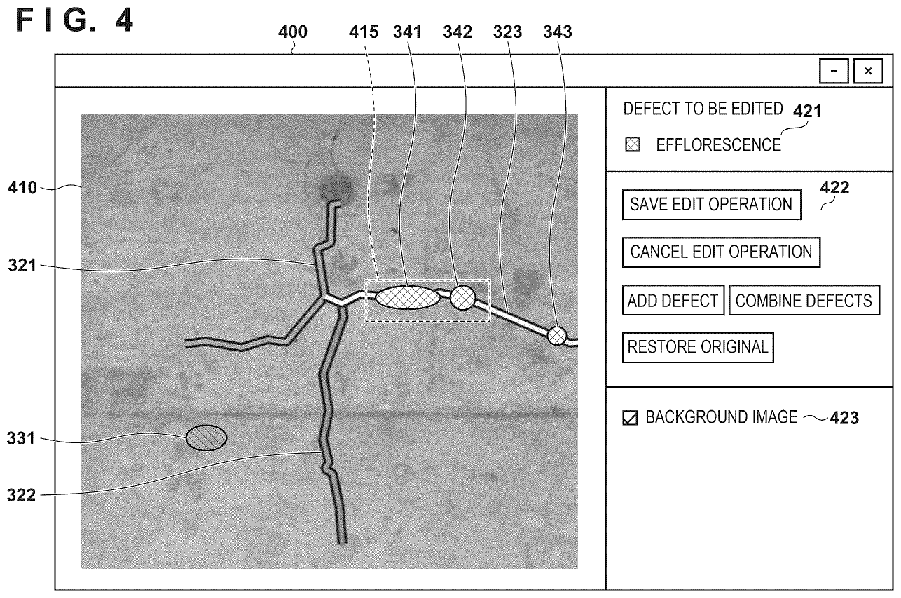

The result management unit 215 has a function of editing the image analysis result stored in the result storage unit 214. The result management unit 215 may have a function of, for example, browsing and obtaining the image analysis result. The result management unit 215 can present a browsing screen for the image analysis result (FIG. 3) and an edit screen for the image analysis result (FIG. 4) to the user. Meanwhile, in detection of a defect through the image analysis, there is a possibility of an occurrence of an erroneous detection or a missed detection. For this reason, the user is allowed to visually confirm the detection result and edit the detection result. Especially, in a case where defect areas are determined through image analysis processing, a group of defects tends to be detected as a plurality of separate defect areas compared to a case where defect areas are manually recorded while an image is viewed. In this case, in order to facilitate examination on (e.g., temporal comparison between) and the search for defect areas, the detection result can be edited so as to combine a plurality of defect areas that have been separately detected.

The result management unit 215 includes a display control unit 221, a designation obtainment unit 222, a determination unit 223, and a combining processing unit 224. The display control unit 221 obtains information of a defect area in an image of a structure, which corresponds to a planar defect in the structure. Also, the display control unit 221 may further obtain information of a defect line in the image of the structure, which corresponds to a line defect in the structure. Then, the display control unit 221 can output a screen showing information of these defect area and defect line (e.g., FIG. 3 and FIG. 4).

As will be described later, the result management unit 215 has a function of editing the detection result so as to combine a plurality of defect areas. The designation obtainment unit 222 accepts a designation of one defect area and another defect area targeted for combining processing. The determination unit 223 determines whether to combine one defect area with another defect area based on the positional relationship between the one defect area and the other defect area. The combining processing unit 224 combines the one defect area with the other defect area based on the result of determination by the determination unit 223. The details of the foregoing processing will be described later.

In the present embodiment, the information processing apparatus 100 executes processing for detecting a defect, and further executes processing for editing a defect detection result. However, the execution of defect detection processing by the information processing apparatus 100 is not indispensable. For example, a defect detection result generated by another information processing apparatus (e.g., at least one of a defect area and a defect line) may be input to the information processing apparatus 100. The result storage unit 214 can store such a defect detection result. In this case, too, the result management unit 215 can edit the detection result stored in the result storage unit 214 in a manner described later.

FIG. 3 is a diagram showing an example of a browsing screen 300 of image analysis results. The user can confirm the image analysis results on such a browsing screen. On the browsing screen 300, the analysis result can be browsed on a per-image basis. The browsing screen 300 includes an analysis result display field 310 and an explanatory note display field 350.

The analysis result display field 310 displays defects detected through image analysis. Defect areas and defect lines corresponding to the defects can be displayed in such a manner that they overlap an inspection target image. In the example of FIG. 3, defect lines 321 to 323, which correspond to cracks; a defect area 331, which corresponds to water leakage; and defect areas 341 to 343, which correspond to efflorescence, are shown. The defect areas and defect lines may be displayed in different modes depending on the attributes of the defects. In this way, the analysis results can be displayed in an identifiable manner. The analysis result of a crack can include actual dimension information of the length and thickness (width) of the crack. In the present case, as shown in FIG. 3, a defect line corresponding to a crack may be in different display forms (e.g., colors and line types) depending on the length or thickness of the crack. Also, as shown in FIG. 3, a defect area may be in different display forms (e.g., patterns) depending on the type of the defect. A defect area may be in different display forms depending on another attribute, such as the size of the defect.

The explanatory note display field 350 shows display forms that each correspond to a defect line or a defect area. In the present example, the explanatory note display field 350 shows display forms that each correspond to a crack width or a defect type. The explanatory note display field 350 may be used to accept an input for designating a defect to be displayed. In the example of FIG. 3, the explanatory note display field 350 includes checkboxes that respectively correspond to defects. Also, whether to display or hide a corresponding defect is switched depending on whether each checkbox is checked.

Note that the actual dimension information of the length or thickness of a crack can be calculated based on the resolution and the number of pixels of a detection target image. Similarly, the actual dimension information (e.g., area) of a defect indicated by a defect area can also be calculated based on the resolution and the number of pixels of a detection target image. Also, by referring to data of a drawing of a structure, the coordinates and actual dimension information of a detected defect can be converted into the coordinates and actual dimension information that conform with the coordinate system of the drawing. The foregoing processing facilitates browsing, editing, and examination of an analysis result performed on the information processing apparatus 100 or an external apparatus.

FIG. 4 is a diagram showing an example of an edit screen of an image analysis result. When an edit button 351, which is provided for each defect type in FIG. 3, has been pressed, a transition is made to the edit screen of FIG. 4. On this edit screen, the result of detection of a defect of a designated type can be edited. On an edit screen 400 shown in FIG. 4, the result of detection of efflorescence can be edited. Meanwhile, on another edit screen, the results of detection of all types of defects may be editable for each image to be detected.

The edit screen 400 includes an edit result display field 410, a defect name field 421, an edit instruction field 422, and a display switching field 423. The defect name field 421 shows the name of a defect to be edited. The edit instruction field 422 displays various types of buttons that are used by the user to input an edit instruction.

The edit result display field 410 displays defect areas and defect lines corresponding to the defects in such a manner that they overlap an inspection target image, similarly to the analysis result display field 310. Note that whether to display the inspection target image (background image) can be switched by an input to the display switching field 423. Meanwhile, defect areas and defect lines corresponding to defects that are not to be edited can be displayed in a mode different from a mode of defect areas and defect lines corresponding to defects to be edited. In the example of FIG. 4, the transparency of defect lines 321 to 323 (which correspond to cracks), a defect area 331 (which corresponds to water leakage), and the like, which correspond to defects that are not to be edited, is set to be higher than that of defect areas 341 to 343 (which correspond to efflorescence), which are defects to be edited. Furthermore, defect areas and defect lines corresponding to defects to be edited can be displayed in such a manner that they are superimposed over defect areas and defect lines corresponding to defects that are not to be edited. In the example of FIG. 4, the defect areas 341 to 343 (which correspond to efflorescence), which are defects to be edited, are in the topmost layer in the order of superimposition.

A frame 415 shown in the edit result display field 410 indicates an application range of processing for combining defect areas. In order to combine a plurality of defect areas corresponding to a single group of defects, the user can set the frame 415 to enclose these plurality of defect areas. Processing for combining defect areas in accordance with the set frame 415 will be described later.

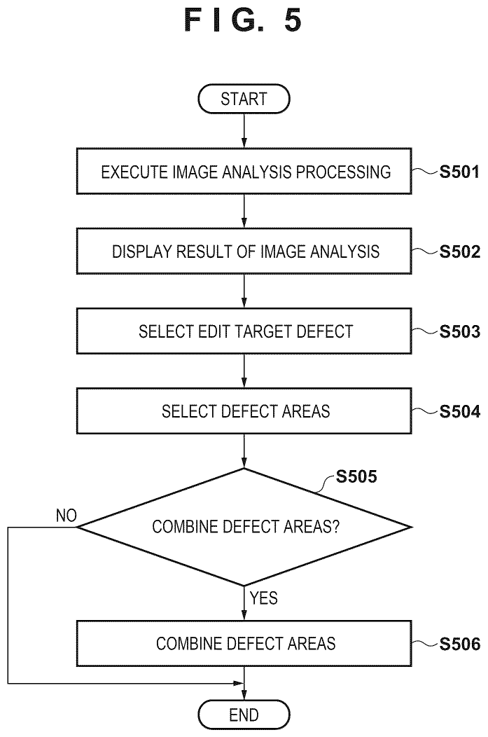

FIG. 5 is a flowchart of processing executed by the information processing apparatus according to the present embodiment. The control unit 101 of the information processing apparatus 100 controls each constituent element and thus realizes the functions shown in FIG. 2 by deploying a program stored in the nonvolatile memory 103 to the volatile memory 102 and executing the program; in this way, processing shown in FIG. 5 is executed.

In step S501, the image analysis unit 213 executes image analysis processing with respect to an inspection target image. In this way, the image analysis unit 213 detects defect lines and defect areas corresponding to defects from the inspection target image.

In step S502, the image analysis unit 213 stores the analysis results obtained in step S501 into the result storage unit 214. The image analysis unit 213 can store, for example, information indicating the positions of the defect lines and the defect areas into the result storage unit 214. Specifically, the image analysis unit 213 can store information indicating the initial points and the terminal points of the respective defect lines into the result storage unit 214. Also, the image analysis unit 213 can store information indicating vertices that define each defect area into the result storage unit 214. Furthermore, the image analysis unit 213 can store information indicating the attributes of the respective defect lines or defect areas (e.g., the widths of cracks or defect types) into the result storage unit 214.

In addition, the display control unit 221 obtains information of defect areas in an image of a structure, which correspond to planar defects in the structure. Then, the display control unit 221 can output information indicating the defect areas. For example, the display control unit 221 can display the analysis results obtained in step S501 on the output apparatus 106. Specifically, the display control unit 221 can display the above-described browsing screen 300 on the output apparatus 106.

In step S503 onward, defect areas are edited in accordance with a user operation. A description is now given of a case where a plurality of defect areas are combined as one example of an editing method. The following description pertains to a case where one defect type (e.g., efflorescence) has been selected as an edit target. In one embodiment, one defect area and another defect area that are targeted for combining processing correspond to defects of the same type. For example, a defect area corresponding to the type of defect to be edited is combined with a defect area corresponding to the type of defect to be edited. On the other hand, a defect area corresponding to a certain type of defect may not be combined with a defect area corresponding to another type. However, as will be described later, defect areas that respectively correspond to different types of defects can also be combined.

In step S503, the designation obtainment unit 222 obtains a user input indicating a type of defect corresponding to the defect areas to be combined. As stated earlier, the user can select a type of defect to be edited (i.e., to be combined) by pressing an edit button 351 that has been provided for each defect type on the browsing screen 300. In the present example, only one type of defect is selected. However, two or more types of defects may be selected. Also, all types of defects may be selected irrespective of the user input.

In step S504, the designation obtainment unit 222 selects defect areas targeted for the combining processing. In accordance with the user input, the designation obtainment unit 222 can select one defect area and another defect area targeted for the combining processing. To this end, the designation obtainment unit 222 can accept a designation of one defect area and another defect area targeted for the combining processing. In this way, the designation obtainment unit 222 can select the defect areas targeted for the combining processing in accordance with the user input.

For example, the designation obtainment unit 222 can accept a designation of a region on an image of a structure. The designation obtainment unit 222 can accept such a designation from the user. The designated region is used as the application range of the combining processing. Then, the designation obtainment unit 222 can specify defect areas in the designated region as one defect area and another defect area to be combined.

Specifically, the user can designate the application range by changing the size and position of the frame 415 on the edit screen 400. Then, the designation obtainment unit 222 selects the defect areas included in the frame 415 as targets of the combining processing. Here, the designation obtainment unit 222 may select the defect areas that are completely enclosed in the frame 415 as targets of the combining processing. Also, the designation obtainment unit 222 may select the defect areas that at least partially overlap a region inside the frame 415 as targets of the combining processing. In a case where a type of defects to be edited has been selected in step S503, the designation obtainment unit 222 can select the defect areas which are included in the frame 415 and which correspond to the type to be edited selected in step S503 as targets of the combining processing.

Note that the designation obtainment unit 222 can present an initial setting of the region to the user. The designation obtainment unit 222 may decide on the initial setting of the region (i.e., the initial arrangement of the frame 415) in accordance with the analysis results (e.g., the positions of defect lines and defect areas). The designation obtainment unit 222 can specify a defect line that passes through the largest number of defect areas among a plurality of defect lines. Then, the designation obtainment unit 222 can present a region that has been set to include all of the defect areas located on the specified defect line to the user as the initial setting. The designation obtainment unit 222 can decide on the initial arrangement of the frame 415 so as to enclose the region that has been set in the foregoing manner. As another example, the designation obtainment unit 222 can select a defect line corresponding to a crack with the largest length or thickness. Then, the designation obtainment unit 222 can decide on the initial arrangement of the frame 415 so as to enclose the selected defect line.

Note that a method of designating defect areas targeted for the combining processing is not limited to the aforementioned methods. For example, the user may directly designate two or more defect areas to be combined. For example, the user may click on two or more defect areas to be combined on the inspection target image on which defect areas are superimposed. Furthermore, in one embodiment, the application range of the combining processing may be automatically set. For example, the designation obtainment unit 222 may set the entirety of the inspection target image as the application range of the combining processing.

In step S505, the determination unit 223 determines whether to combine the defect areas targeted for the combining processing, which have been selected in step S504. That is to say, the determination unit 223 determines whether to combine one defect area with another defect area based on the positional relationship between the one defect area and the other defect area. In this way, the determination unit 223 can determine whether to combine defect areas based on position information of each defect area.

In the present embodiment, the determination unit 223 determines whether to combine one defect area with another defect area based on the positional relationship among the one defect area, the other defect area, and a defect line. In this way, the determination unit 223 can determine whether to combine defect areas based on position information of a defect line in addition to position information of each defect area. In the present embodiment, the determination unit 223 determines whether to combine one defect area with another defect area based on whether the one defect area and the other defect area exist on one defect line. In a case where the application range of the combining processing has been set in the foregoing manner, the determination unit 223 can determine whether to combine a plurality of defect areas included in the application range designated in step S504 based on whether the plurality of defect areas are on one defect line. In a case where the determination unit 223 has determined that these plurality of defect areas are on one defect line, processing proceeds to step S506. In a case where the determination unit 223 has not thus determined, processing ends.

Note that the attributes of defect lines that are referred to in this processing may be restricted. That is to say, the determination unit 223 determines whether to combine one defect area with another defect area based on the positional relationship among the one defect area, the other defect area, and a defect line having a specific attribute. Such a defect line having a specific attribute may be, for example, a defect line corresponding to a crack whose width falls within a specific range.

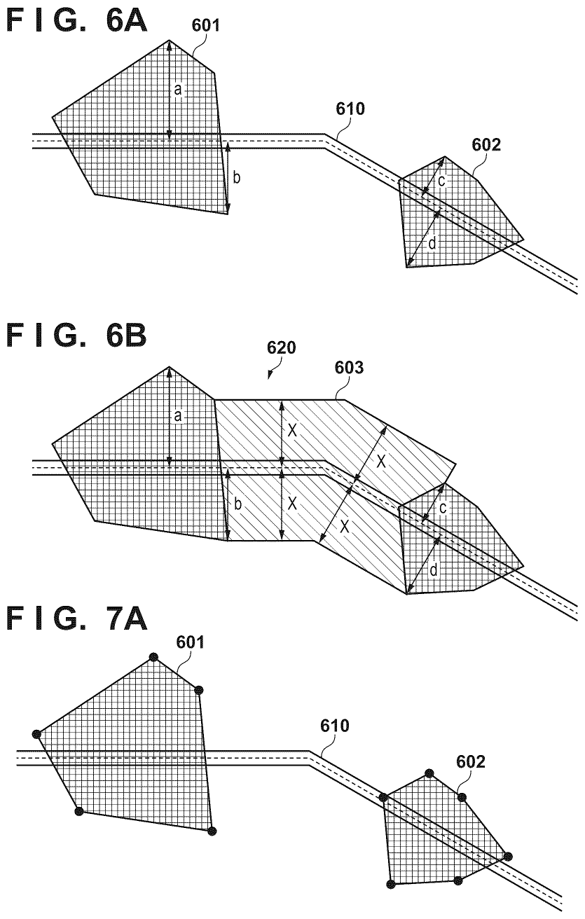

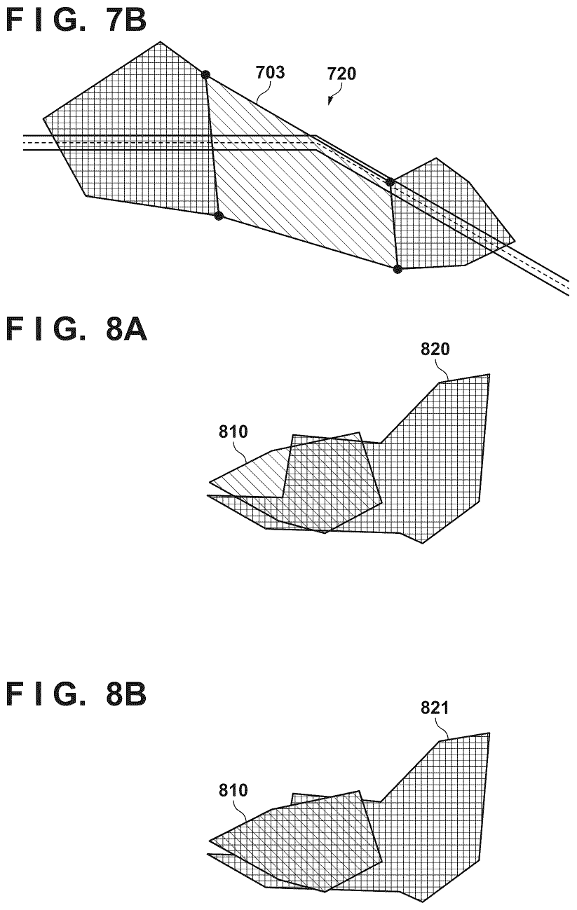

In step S506, the combining processing unit 224 combines one defect area with another defect area based on the result of determination made by the determination unit 223. That is to say, the combining processing unit 224 can combine the defect areas selected in step S504. In this way, the combining processing unit 224 generates a new defect area. In the present embodiment, the combining processing unit 224 combines a plurality of defect areas on each defect line. A combining method will be described later in detail using FIGS. 6A and 6B and FIGS. 7A and 7B. In the example of FIG. 4, the defect area 341 corresponding to efflorescence and the defect area 342 corresponding to efflorescence, which are on the crack 323, are combined. Although the defect area 343 corresponding to efflorescence is on the crack 323, it is not combined with another defect area because it is not inside the frame 415. The combining processing unit 224 can record the new defect area in place of the one defect area and the other defect area. In the present example, the one defect area and the other defect area correspond to the type of defects to be edited, and the new defect area also corresponds to the same type of defect.

Several examples of the method of combining defect areas will be described with reference to FIGS. 6A and 6B and FIGS. 7A and 7B. The combining method used by the combining processing unit 224 is not limited in particular. For example, the combining processing unit 224 may combine defect areas using one of the methods described below. Also, the combining processing unit 224 may combine one defect area with another defect area in accordance with a method that has been selected by the user from among two or more methods.

In one embodiment, a new defect area obtained by combining one defect area with another defect area includes the one defect area, the other defect area, and a region between the one defect area and the other defect area. FIG. 6A and FIG. 7A show two defect areas 601 and 602 before the combining, which are on one defect line 610. Also, FIG. 6B and FIG. 7B show defect areas 620 and 720 after the combining. Each of the defect areas 620 and 720 includes not only the defect areas 601 and 602 before the combining, but also an additional area 603 or 703, which is a defect area that has been added as a result of the combining.

In the method shown in FIGS. 6A and 6B, with respect to each of the defect area 601 and the defect area 602, the combining processing unit 224 first determines a point that is farthest from the defect line 610 that passes through the defect area among the points that define the contour, and obtains a distance a or d between this point and the defect line. Next, with respect to each of the defect area 601 and the defect area 602, the combining processing unit 224 determines a point which is on the opposite side of the point that has been determined in the foregoing manner across the defect line 610, and which is farthest from the defect line that passes through the defect area, among the points that define the contour. Then, the combining processing unit 224 obtains a distance b or c between this point and the defect line. Furthermore, the combining processing unit 224 obtains an average distance X of the distances a to d. Then, the combining processing unit 224 determines an area obtained by expanding the width of the defect line 610 that passes through the defect areas 601 and 602 by the distance X between these defect areas as an additional area 603. This additional area is a region which is located between the defect area 601 and the defect area 602, and which is at or within the distance X from the defect line 610. The defect area 620 after the combining is a region obtained by adding the additional area 603 to the defect area 601 and the defect area 602.

Note that a method of determining an additional area is not limited to the above-described method. As stated earlier, the additional area 603 can be a region that is at or within the distance X from the defect line 610. This distance X may be the longest distance or the shortest distance among the distances a to d. Also, this distance X may be determined on in accordance with the width of the crack corresponding to the defect line 610. Furthermore, this distance X may be arbitrarily selected by the user.

As described above, the combining processing unit 224 can generate a new defect area, by way of combining, so that the new defect area includes one defect area, another defect area, and a region (additional area) that extends along the defect line between the one defect area and the other defect area. Also, a region that extends along the defect line between the one defect area and the other defect area may be a region that is defined by expanding the defect line by an expansion width (the aforementioned distance X) in the width direction between the one defect area and the other defect area. The combining processing unit 224 can set this expansion width in accordance with the size of the one defect area or the other defect area. Specifically, as shown in FIGS. 6A and 6B, the combining processing unit 224 can set this expansion width in accordance with a distance between a point that defines the contour of the one defect area or the other defect area and the defect line.

In the method shown in FIGS. 7A and 7B, the combining processing unit 224 first calculates the distances between the discrete vertices that define the defect area 601 and the discrete vertices that define the defect area 602. Then, the combining processing unit 224 determines a line between a vertex that defines the defect area 601 and a vertex that defines the defect area 602, and a line between another vertex that defines the defect area 601 and another vertex that defines the defect area 602, so that the two lines are the shortest. For example, the combining processing unit 224 may select these two lines so that the sum of the lengths of the two lines is the smallest. Furthermore, the combining processing unit 224 may select the first line that is the shortest, and the second line that is the shortest among the lines between the remaining vertices. At this time, the combining processing unit 224 can select the two lines that do not intersect each other. Note that the combining processing unit 224 may select the two lines that are the longest. Then, the combining processing unit 224 determines a region sandwiched between these two lines as the additional area 703. The defect area 720 after the combining is a region obtained by adding the additional area 703 to the defect area 601 and the defect area 602. As described above, the additional area may be a region sandwiched between two lines that connect the contour of one defect area and the contour of another defect area.

According to the present embodiment, the results of detection of defects can be corrected so as to combine defect areas. Especially, a defect tends to spread along a crack. For this reason, a group of planar defects may be detected as a plurality of separate defect areas that extend along a crack. Therefore, in a case where a plurality of defect areas have been detected along a crack, there is a high possibility that these plurality of defect areas represent a group of defects. Thus, in the present embodiment, a plurality of defect areas that have been detected along a crack are combined. Meanwhile, defect areas can be combined so that a plurality of defect areas that do not extend along one crack are not combined. This allows the user to appropriately combine a plurality of defect areas merely by performing a simple operation of setting a frame that includes defect areas to be combined on an image. As a result, the user can easily grasp a connection relationship between defect areas. Furthermore, defect areas can easily be examined and searched for.

### Modification Example

In the above-described embodiment, the determination unit 223 determines to combine a plurality of defect areas in a case where the plurality of defect areas exist on one defect line. However, the method of determining whether to combine a plurality of defect areas is not limited to the foregoing method. For example, the determination unit 223 may determine whether to combine one defect area with another defect area based on whether the one defect area and the other defect area exist at or within a predetermined distance from one defect line. In this case, the determination unit 223 can determine to combine a plurality of defect areas in a case where these plurality of defect areas are at a distance equal to or shorter than a threshold from one defect line.

Also, in the above-described embodiment, the determination unit 223 determines whether to combine a plurality of defect areas based on the positional relationship between the plurality of defect areas and a defect line. On the other hand, the determination unit 223 may determine whether to combine a plurality of defect areas irrespective of the position of a defect line. In this case, the detection of defect lines by the information processing apparatus 100 is not indispensable. For example, the determination unit 223 may determine whether to combine a plurality of defect areas based on the distance between the plurality of defect areas. Specifically, the determination unit 223 can determine to combine a plurality of defect areas in a case where the distance between these plurality of defect areas is equal to or shorter than a threshold.

The above embodiment has been described in relation to a case where mainly a plurality of defect areas that represent the same type of defects (e.g., efflorescence) are combined. However, the information processing apparatus 100 may combine a plurality of defect areas that respectively represent different types of defects. That is to say, one defect area and another defect area to be combined may corresponding to different types of defects.

The method of combining a plurality of defect areas that respectively represent different types of defects is not limited in particular. For example, the combining processing unit 224 can generate a new defect area by combining one defect area corresponding to a specific defect with another defect area corresponding to a different defect. This new defect area is a defect area corresponding to the specific defect. As a result of the combining processing, one defect area corresponding to the specific defect is replaced with the new defect area corresponding to the specific defect. Meanwhile, another defect area corresponding to the different defect may be maintained.

This example will be described with reference to FIGS. 8A and 8B. In the present example, a plurality of defect areas are combined based on position information of the plurality of defect areas. Specifically, the determination unit 223 can determine whether to combine one defect area with another defect area based on a degree of overlap between the one defect area and the other defect area. A degree of overlap between defect areas can be defined based on the area of an overlapping portion or the ratio of the overlapping portion. For example, the determination unit 223 can determine to combine the plurality of defect areas in a case where the degree of overlap is equal to or higher than a threshold. Also, the determination unit 223 may determine whether to combine the plurality of defect areas in accordance with the types of defects that are respectively represented by the plurality of defect areas. Furthermore, the determination unit 223 may inquire with the user about whether to combine a plurality of defect areas corresponding to different types of defects in a case where the degree of overlap is equal to or higher than the threshold. In this case, the display control unit 221 may display the defect areas corresponding to the inquiry in a display form different from a display form of other defect areas on the edit screen 400 so that the defect areas corresponding to the inquiry can be identified.

Also, in one embodiment, the determination unit 223 determines whether to combine one defect area with another defect area in accordance with whether the type of a defect corresponding to the other defect area is a predetermined type that corresponds to the type of a defect corresponding to the one defect area. The following describes, as one example, a case where an exposed steel bar has been selected as an edit target. In the example of FIGS. 8A and 8B, a defect area 810 corresponding to a rusty fluid and a defect area 820 corresponding to an exposed steel bar have been detected. Also, the application range of the combining processing includes the defect area 820 corresponding to the exposed steel bar. Incidentally, a rusty fluid is easily produced in the site of an exposed steel bar. Also, there is a possibility that a part of the site of the exposed steel bar is not detected as it is hidden by the rusty fluid. For this reason, it is possible to determine, in advance, to combine a defect area corresponding to an exposed steel bar with a defect area corresponding to a rusty fluid.

In one embodiment, the determination unit 223 determines whether there is a defect area 810 corresponding to a rusty fluid which overlaps the defect area 820 corresponding to the edit target, namely the exposed steel bar, and which has a degree of overlap equal to or higher than the threshold. In a case where such a defect area 810 exists, the combining processing unit 224 combines the defect area 820 with the defect area 810, thereby generating a defect area 821. The combining processing unit 224 generates such a defect area 821 as a defect area corresponding to the exposed steel bar. At this time, the defect area 810 corresponding to the rusty fluid is maintained.

In this way, even in a case where a defect line has not been detected, the results of detection of defects can be corrected to combine defect areas.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-212324, which was filed on Dec. 15, 2023 and which is hereby incorporated by reference herein in its entirety.

What is claimed is:

1. An information processing apparatus comprising:
one or more memories storing instructions; and
one or more processors that execute the instructions to:
obtain information of defect areas in an image of a structure, the defect areas corresponding to planar defects in the structure;
determine whether to combine one defect area with another defect area based on a positional relationship between the one defect area and the other defect area; and
combine the one defect area with the other defect area based on a result of the determination.

2. The information processing apparatus according to claim 1, wherein the one or more processors execute the instructions to:
obtain information of a defect line in the image of the structure, the defect line corresponding to a line defect in the structure; and
determine whether to combine the one defect area with the other defect area based on a positional relationship among the one defect area, the other defect area, and the defect line.

3. The information processing apparatus according to claim 2, wherein the one or more processors execute the instructions to determine whether to combine the one defect area with the other defect area based on whether the one defect area and the other defect area exist on the defect line.

4. The information processing apparatus according to claim 2, wherein the one or more processors execute the instructions to determine whether to combine the one defect area with the other defect area based on whether the one defect area and the other defect area exist at or within a predetermined distance from the defect line.

5. The information processing apparatus according to claim 2, wherein the defect line corresponds to at least one of a crack and a line mark in the structure.

6. The information processing apparatus according to claim 2, wherein
the one or more processors execute the instructions to generate a new defect area by combining the one defect area with the other defect area, and
the new defect area includes the one defect area, the other defect area, and a region that extends along the defect line between the one defect area and the other defect area.

7. The information processing apparatus according to claim 6, wherein
the new defect area includes the one defect area, the other defect area, and a region defined by expanding the defect line by an expansion width in a width direction between the one defect area and the other defect area, and
the expansion width is set in accordance with a distance between a point that defines a contour of the one defect area or the other defect area and the defect line.

8. The information processing apparatus according to claim 1, wherein
the one or more processors execute the instructions to generate a new defect area by combining the one defect area with the other defect area,
the new defect area includes the one defect area, the other defect area, and a region between the one defect area and the other defect area, and
the region between the one defect area and the other defect area is a region sandwiched between two lines connecting a contour of the one defect area and a contour of the other defect area.

9. The information processing apparatus according to claim 1, wherein the defect areas correspond to areas in which at least one of water leakage, exfoliation, efflorescence, an exposed steel bar, and a rusty fluid has occurred in the structure.

10. The information processing apparatus according to claim 1, wherein the one defect area and the other defect area correspond to defects of the same type.

11. The information processing apparatus according to claim 1, wherein the one defect area and the other defect area correspond to different types of defects.

12. The information processing apparatus according to claim 11, wherein the one or more processors execute the instructions to determine whether to combine the one defect area with the other defect area based on whether a type of a defect corresponding to the other defect area is a predetermined type that corresponds to a type of a defect corresponding to the one defect area.

13. The information processing apparatus according to claim 11, wherein the one or more processors execute the instructions to determine whether to combine the one defect area with the other defect area based on a degree of overlap between the one defect area and the other defect area.

14. The information processing apparatus according to claim 11, wherein the one or more processors execute the instructions to combine the one defect area corresponding to a specific defect with the other defect area corresponding to a different defect, thereby generating a new defect area which corresponds to the specific defect and which includes the one defect area and the other defect area.

15. The information processing apparatus according to claim 1, wherein the one or more processors execute the instructions to combine the one defect area with the other defect area in accordance with a method that has been selected by a user from among two or more methods.

16. The information processing apparatus according to claim 1, wherein the one or more processors execute the instructions to accept a designation of the one defect area and the other defect area.

17. The information processing apparatus according to claim 16, wherein the one or more processors execute the instructions to accept a designation of a region on the image of the structure, and specify defect areas in the region as the one defect area and the other defect area.

18. The information processing apparatus according to claim 17, wherein the one or more processors execute the instructions to:
obtain information of a plurality of defect lines in the image of the structure, the plurality of defect lines respectively corresponding to line defects in the structure; and
specify a defect line that passes through the largest number of defect areas among the plurality of defect lines, and present the region that has been set to include all of defect areas located on the specified defect line to a user as an initial setting.

19. An information processing method comprising:
obtaining information of defect areas in an image of a structure, the defect areas corresponding to planar defects in the structure;
determining whether to combine one defect area with another defect area based on a positional relationship between the one defect area and the other defect area; and
combining the one defect area with the other defect area based on a result of the determination.

20. A non-transitory computer-readable medium storing a instructions that are executable by a computer to perform a method comprising:
obtaining information of defect areas in an image of a structure, the defect areas corresponding to planar defects in the structure;
determining whether to combine one defect area with another defect area based on a positional relationship between the one defect area and the other defect area; and
combining the one defect area with the other defect area based on a result of the determination.
